(19) United States
(12) Patent Application Publication
(10) Pub. No.: US 2010/0332207 A1
(43) Pub. Date: Dec. 30, 2010

(54) VIA IMPEDANCE MATCHING METHOD

(75) Inventor: WEN-CHUNG WANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/547,606

(22) Filed: Aug. 26, 2009

(30) Foreign Application Priority Data
Jun. 29, 2009 (CN) 200910303787.8

(51) Int. Cl. G06F 17/50

(52) U.S. Cl. 703/14

(57) ABSTRACT

A via impedance matching method is provided. Firstly, a circuit model of a via in the PCB is created, which comprises a low pass filter circuit composed of two capacitors connected in parallel and an inductor connected between the two capacitors. Then, S parameters of the via by analyzing the circuit model is obtained and converted to an ABCD matrix, and parameters of an ideal low pass filter model is obtained by equaling an ABCD matrix of the ideal low pass filter model to the ABCD matrix with the S parameters. Then, impedance matching parameters are calculated according to the parameters of the ideal low pass filter model. Finally, proper capacitors and inductors are selected and disposed on the PCB to match the via.

### BACKGROUND

1. Technical Field

The present disclosure relates to a via impedance matching method.

2. Description of Related Art

With the development of digital communication, most electronic devices, such as computers, mobile phones and network systems, function at high data transmission speeds. Accordingly, signal integrity is important to transmission, becoming a priority in the design of utilized printed circuit board (PCB). In such design, it is important that impedance of vias defined in the PCB be properly matched, to avoid distortion of the signals.

### BRIEF DESCRIPTION OF THE DRAWINGS

FIG. 1 is a schematic diagram of a printed circuit board (PCB) with a via;

FIGS. 2 and 3 are equivalent circuit models of the via of FIG. 1;

FIG. 4 is a mapping table between Y, Z, S parameters and ABCD matrices;

FIG. 5 is a typical equivalent circuit model of a π-type two-port network; and

FIG. 6 is a flowchart of a method for matching via's impedance.

### DETAILED DESCRIPTION

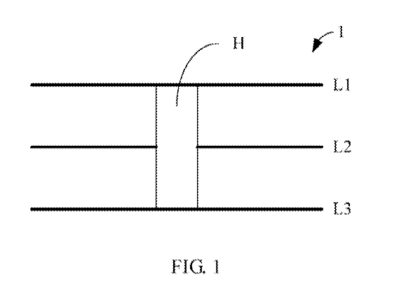

FIG. 1 is a schematic diagram of a printed circuit board (PCB) 1 defining a via H. As shown, the PCB has three layers L1, L2, L3 and a plurality of components disposed thereon and the via H defined therein. The layers L1, L2, L3 are electrically connected by the via H. Alternatively, the PCB can comprise multiple layers other than three.

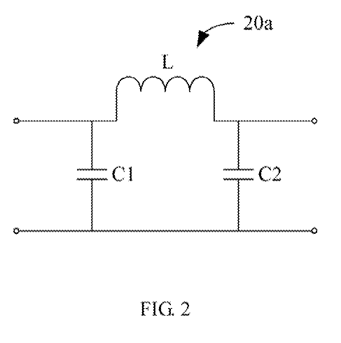

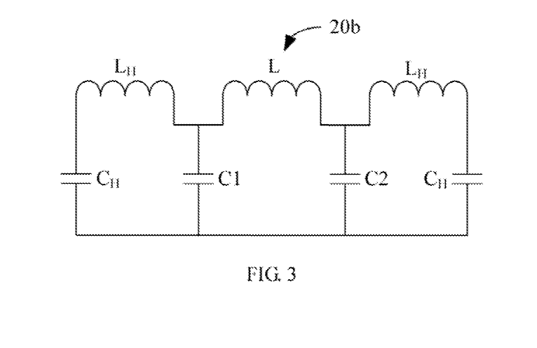

FIG. 2 is an equivalent circuit model of the via H of FIG. 1 and FIG. 3 is an equivalent circuit model of the via H with impedance match of FIG. 1. In one embodiment, capacitors C1, C2 represent equivalent capacitance between cooper foils disposed on the layers L1, L2 and L3, and an inductor L represents equivalent inductance of the via H. Thus, the PCB with the via H equals a π-type two-port network 20a. Because impedance of the via H is unmatched, high frequency signals transmitted through the via H can be distorted. In order to match the impedance of the via H and ensure performance quality of the high frequency signals transmitted through the via H, the capacitors C1, C2 and the inductor L must substantially match. The matched capacitors and inductor are respectively labeled as C_{H} and L_{H}. Thus, proper impedance matching can be made by disposed the capacitors C_{H} and the inductors L_{H} having the proper capacitance and inductance values on the PCB 1.

It is well known that Y, Z, S parameters can be used to measure and analyze a high frequency two-port network. The Y parameters are admittance parameters, the Z parameters are impedance parameters, and the S parameters are scattering parameters.

When the circuit model of the PCB with the via H is first created, the S parameters of the via H may be obtained by analyzing the circuit model with electromagnetic simulation software, for example.

The S parameters are converted to an ABCD matrix according to a mapping table between the parameters Y, X, S and ABCD matrices shown in FIG. 3. The mapping table of FIG. 3 is obtained by several mathematical calculations of relation between the Y, Z, S parameters, which is a standard table. In the mapping table, formulae of A, B, C, D of an ABCD matrix with the S parameters are

$$A = \frac{( 1 + {S}_{11} ) ( 1 - {S}_{22} ) + {S}_{12} {S}_{21}}{2 {S}_{21}} ;$$

$$B = {Z}_{0} \frac{( 1 + {S}_{11} ) ( 1 + {S}_{22} ) - {S}_{12} {S}_{21}}{2 {S}_{21}} ;$$

$$C = \frac{1}{{Z}_{0}} \frac{( 1 - {S}_{11} ) ( 1 - {S}_{22} ) - {S}_{12} {S}_{21}}{2 {S}_{21}} ;$$

$$D = \frac{( 1 - {S}_{11} ) ( 1 + {S}_{22} ) + {S}_{12} {S}_{21}}{2 {S}_{21}} ;$$

wherein Z₀=50Ω, in one example. Because the S parameters are analyzed, the values of A, B, C, D can be calculated. Similarly, the Z, Y parameters are converted to the ABCD matrices with the Z, Y parameters according to the mapping table.

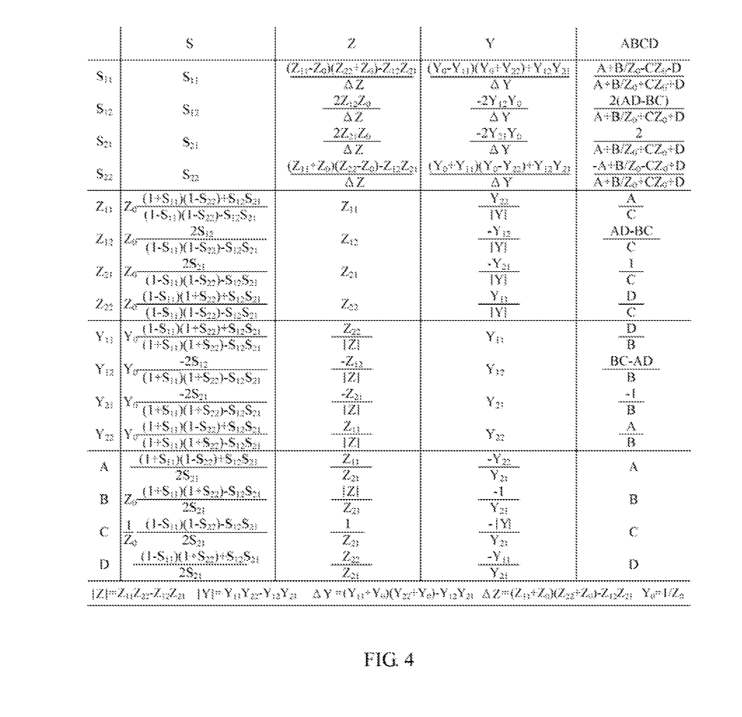

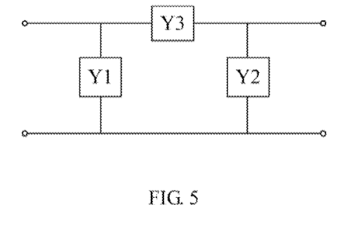

A typical equivalent circuit model of a π-type two-port network is shown in FIG. 4, which is an ideal low pass filter. Formulae of A, B, C, D of an ABCD matrix with Y parameters are

$$A = 1 + \frac{{Y}_{2}}{{Y}_{3}} ; B = \frac{1}{{Y}_{3}} ; C = {Y}_{1} + {Y}_{2} + \frac{{Y}_{1} {Y}_{2}}{{Y}_{3}} ; D = 1 + \frac{{Y}_{1}}{{Y}_{3}} .$$

Similarly, the ABCD matrix of the π-type two-port network is calculated by several times to become a standard matrix.

The via H has a low pass filter characteristic, thus, impedance match of the via H is close to an ideal value only when the circuit model of PCB is close to the circuit model of the ideal two-port network. Therefore, the signal through the via H has good performance.

In detail, the ABCD matrix with S parameters of circuit model of the PCB equals that of the ABCD matrix with Y parameters of the ideal circuit model of the PCB, that is,

$$1 + \frac{{Y}_{2}}{{Y}_{3}} = \frac{( 1 + {S}_{11} ) ( 1 - {S}_{22} ) + {S}_{12} {S}_{21}}{2 {S}_{21}} ;$$

$$\frac{1}{{Y}_{3}} = {Z}_{0} \frac{( 1 + {S}_{11} ) ( 1 + {S}_{22} ) - {S}_{12} {S}_{21}}{2 {S}_{21}} ;$$

$${Y}_{1} + {Y}_{2} + \frac{{Y}_{1} {Y}_{2}}{{Y}_{3}} = \frac{1}{{Z}_{0}} \frac{( 1 - {S}_{11} ) ( 1 - {S}_{22} ) - {S}_{12} {S}_{21}}{2 {S}_{21}} ;$$

$$1 + \frac{{Y}_{1}}{{Y}_{3}} = \frac{( 1 - {S}_{11} ) ( 1 + {S}_{22} ) + {S}_{12} {S}_{21}}{2 {S}_{21}} .$$

The ABCD matrix with S parameters is calculated as shown, thus, the values Y₁, Y₂, Y₃ are also calculated. Therefore, according to the circuit model of FIG. 2(b), the impedance match parameters of the via H, that is, matched capacitor C_{H} and matched inductor L_{H} can be calculated by calculating several times.

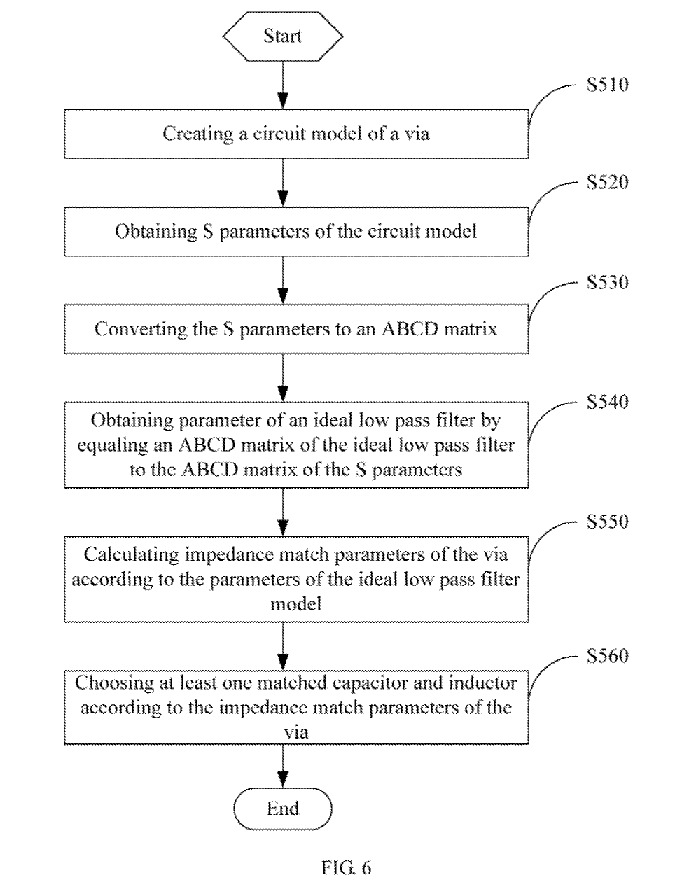

FIG. 6 is a flowchart of a method for matching a via' impedance. In a step S510, an equivalent circuit model of the via H is created. In one embodiment, the equivalent circuit model is a low pass filter of a two-port network, which comprises two capacitors C1, C2 connected in parallel, and an inductor L connected between the two capacitors C1, C2.

In a step S520, the equivalent circuit model may be analyzed by an electromagnetic simulation software to obtain S parameters of the via H.

In a step S530, an ABCD matrix with S parameters is converted in a mapping table between Y, X, S parameters and ABCD matrices.

In a step S540, parameters of an ideal low pass filter, that is, Y1, Y2, Y3, can be calculated when the ABCD matrix with Y parameters of the ideal low pass filter equals the ABCD matrix with S parameters.

In a step S550, impedance match parameters of the via H are determined. That is, values of the matched capacitor C_{H} and matched inductor L_{H} can be calculated according to those of the capacitors C1, C2, the inductor L and parameters Y of the ideal low pass filter.

In a step S560, at least one capacitor and inductor are chosen according to the values of the matched capacitor C_{H} and matched inductor L_{H}, and disposed on the PCB1 to match the impedance of the via H. In one embodiment, the matched capacitor C_{H} is connected to the capacitors C₁, C₂ in parallel, and the matched inductor L_{H} is connected to the inductor L in series.

The disclosure utilizes simulation software to analyze S parameters of the via H, compares the circuit model of the via H to an ideal low pass filter, calculates Y parameters of the ideal low pass filter, and calculates impedance match parameters of the via H. Thus, proper impedance matching can be made by adding the proper capacitor and inductors having the proper capacitance and inductance values onto the PCB 1.

Although the features and elements of the present disclosure are described in various inventive embodiments in particular combinations, each feature or element can be configured alone or in various within the principles of the present disclosure to the full extent indicated by the broad general meaning of the terms in which the appended claims are expressed.

What is claimed is:

1. A via impedance matching method for a via defined in a printed circuit board (PCB) that comprises a plurality of components disposed thereon, the method comprising:
creating a circuit model of the via, wherein the circuit model comprises a low pass filter circuit composed of two capacitors connected in parallel and an inductor connected between the two capacitors;
obtaining S parameters of the via based on simulation analysis of the circuit model;
converting the S parameters to an ABCD matrix with the S parameters;
obtaining parameters of an ideal low pass filter circuit model by equaling an ABCD matrix of the ideal low pass filter circuit model to the ABCD matrix with the S parameters;
calculating impedance match parameters of the via according to the parameters of the ideal low pass filter circuit model; and
selecting at least one matched capacitor and inductor according to the impedance match parameters of the via, and disposing them on the PCB to match the impedance of the via, wherein the matched capacitor is connected to the two capacitors in parallel, and the matched inductor is connected to the inductor in series.

2. The method for matching via's impedance as claimed in claim 1, wherein the S parameters are analyzed by electromagnetic simulation software.

3. The method for matching via's impedance as claimed in claim 1, wherein the ideal low pass filter model is a π-type two-port network model.

4. The method for matching via's impedance as claimed in claim 1, wherein the parameters of the ideal low pass filter are Y parameters, and the ABCD matrix of the ideal low pass filter is an ABCD matrix with the Y parameters.

5. The method for matching via's impedance as claimed in claim 1, wherein the Y parameters are admittance parameters.
